(19) United States
(12) Patent Application Publication
(10) Pub. No.: US 2007/0052717 A1
(43) Pub. Date: Mar. 8, 2007

(54) 3D GRAPHICS PROCESSING METHOD AND DEVICE

(76) Inventors: Ko-Fang Wang, Taipei (TW); Hung-Chang Chen, Taipei (TW); Yu-Chang Wang, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/425,643

(22) Filed: Jun. 21, 2006

(30) Foreign Application Priority Data
Sep. 5, 2005 (TW) 094130417

(51) Int. Cl. G09G 5/00

(52) U.S. Cl. 345/581

(57) ABSTRACT

A X-Y plane is divided into a plurality of tile rows. Each tile row covered by a triangle to be processed includes one or more tiles. The tiles in the same tile row are rastered in a specified order.

### FIELD OF THE INVENTION

The present invention relates to a three-dimensional graphics processing method, and more particularly to a 3D graphics processing method used in a computer graphics system. The present invention also relates to a 3D graphics processing device.

### BACKGROUND OF THE INVENTION

When a three-dimensional image is synthesized by a computer system, data of a plurality of objects need to be read from a database and then converted to data in common world coordinates. Afterwards, the computer system generates view coordinates by defining a view point, just like what happens in the real world. Due to the limitation in the hardware resolution of a computer graphics system, the mathematic expressions of the objects, which are supposed to be continuous, are mapped to 3D display coordinate data, i.e. X-, Y- and Z-coordinate data, which are basically discrete. After hidden surface elimination and rendering operation of object pixels, the resulting graphics data are stored in a frame buffer and then outputted to the display. In general, the graphics system includes two major parts, i.e. geometric subsystem and raster subsystem. The values in local coordinate, world coordinate and view coordinate are three-dimensional and continuous. In order to assure of the accuracy between coordinates, floating points are commonly used to indicate coordinate values. The geometric subsystem takes charge of coordinate conversion operations, and the associated hardware for speeding such operations is a geometric engine. On the other hand, the raster subsystem transforms the object-oriented primitive to pixel-oriented information so as to define the display coordinates by integers, and the associated hardware for speeding such operations is a raster engine. The data involved in these operations are enormous but regular, so the speeding hardware preferably exhibits parallel processing capability.

Please refer to FIG. 1, in which a primitive triangle used for 3D graphics processing is schematically shown. Frame 10 defines X-Y plane, and top point (Xt,Yt,Attt), bottom point (Xb,Yb,Attb) and middle point (Xm,Ym,Attm) of the triangle are used to define plane equation Att(X,Y)=Att0+AX+BY, which reflects the position of the triangle in the 3D space. In the above expression, symbol Att indicates the attribute value of a certain point and for example, includes the depth value (Z value) and the color value of the point. The symbols X, Y, Att, A and B are expressed by floating points. According to the plane equation, attribute values such as Z values and color values of all other pixels in the triangle except the three vertex points can be calculated. After the color value of each pixel is obtained, rasterization operations can be performed.

It is understood from the plane equation Att(X,Y)=Att0+AX+BY, a multiplier is needed in the graphics engine for operating AX and BY. With the increase of the display size, bit numbers for expressing X and Y values in the display coordinates increase. For currently commercialized 2048×2048 display size, 11 bits are needed for each of the X and Y values. In other words, the multiplier of the graphics engine has to be able to process 11-bit multiplying operations. It would become critical in dealing with the hardware cost and the operational speed of the graphics engine.

### SUMMARY OF THE INVENTION

Therefore, the present invention provides a 3D graphics processing method used in a computer graphics system, which is reduced in cost while enhanced in operational speed.

The present invention relates to a 3D graphics processing method in one aspect. The 3D graphics processing method includes steps of: dividing a X-Y plane consisting of M×N pixels into a plurality of tiles consisting of P×Q pixels; inputting X- and Y-coordinate values and attribute values of first, second and third vertex points of a triangle into a geometric engine; defining a plane equation and three line equations of the triangle by the geometric engine according to the X- and Y-coordinate values and attribute values of the first, second and third vertex points; calculating an attribute value of a starting point that is located in a first tile along with the first vertex point by the geometric engine according to the X- and Y-coordinate and attribute values of the first vertex point and the plane equation; inputting information of the starting point, X and Y partial derivatives complying with the plane equation and slopes of the three line equations into a raster engine; calculating Y values of left and right margins of the triangle in the first tile according to two of the three line equations, thereby locating points in the first tile to be rastered by the raster engine; and calculating attribute values of the points to be rastered according to information of the starting point and X and Y partial derivatives complying with the plane equation.

Preferably, the starting point is an edge point of the first tile.

In an embodiment, the right tile is rastered prior to the left tile. When more than one right tile is defined in the certain tile row, the left tile is rastered after all the right tiles are rastered.

The present invention relates to a 3D graphics processing device for processing a X-Y plane in another aspect. The X-Y plane consisting of M×N pixels is divided into a plurality of tiles consisting of P×Q pixels,. The 3D graphics processing device comprises: a geometric engine defining a plane equation and three line equations of a triangle according to X- and Y-coordinate values and attribute values of first, second and third vertex points of the triangle, calculating an attribute value of a starting point that is located in a first tile along with the first vertex point according to the X- and Y-coordinate and attribute values of the first vertex point and the plane equation, and outputting information of the starting point, X and Y partial derivatives complying with the plane equation and slopes of the three line equations; and a raster engine in communication with the geometric engine receiving the information of the starting point, X and Y partial derivatives complying with the plane equation and slopes of the three line equations from the geometric engine, calculating Y values of left and right margins of the triangle in the first tile according to two of the three line equations to locate points in the first tile to be rastered, and calculating attribute values of the points to be rastered according to the information of the starting point and X and Y partial derivatives complying with the plane equation.

### BRIEF DESCRIPTION OF THE DRAWINGS

The present invention may best be understood through the following description with reference to the accompanying drawings, in which:

FIG. 1 is a schematic plot showing a triangle used in 3D image processing means as a basic unit;

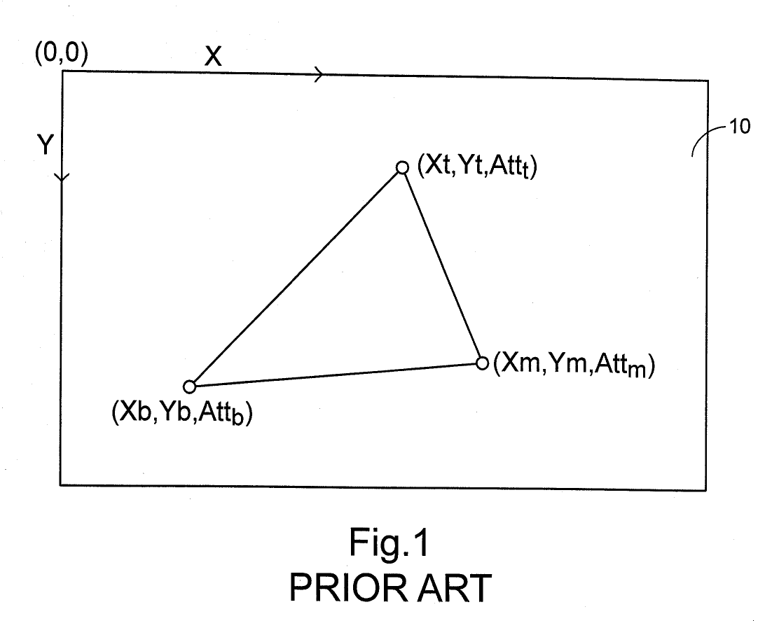

FIG. 2 is a functional block diagram schematically illustrating a 3D graphics processing device according to an embodiment of the present invention;

FIG. 3 is a schematic diagram illustrating the area covered by a triangle and its raster order; and

FIG. 4 is a flowchart illustrating the determination of raster order in a 3D graphics processing method according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

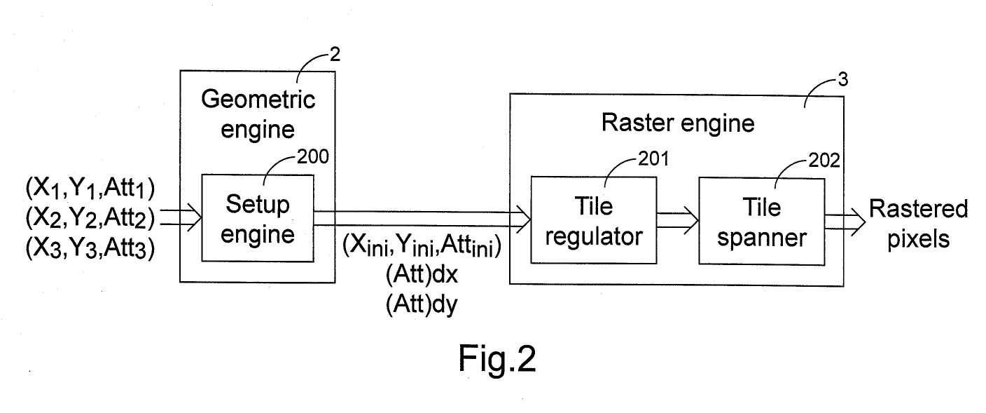

As shown in FIG. 2, a 3D graphics processing device according to an embodiment of the present invention includes geometric engine 2 and raster engine 3. Geometric engine 2 can be implemented with a setup engine 200 and raster engine 3 can be implemented with tile regulator 201 and tile spanner 202. Setup engine 200 reads X- and Y-coordinate values and attribute values of three vertex points of a triangle, i.e. first vertex point (X1,Y1,Att1), second vertex point (X2,Y2,Att2) and third vertex point (X3,Y3,Att3), wherein the attribute values may include Z values indicative of depth in the three-dimensional space and color values, etc.

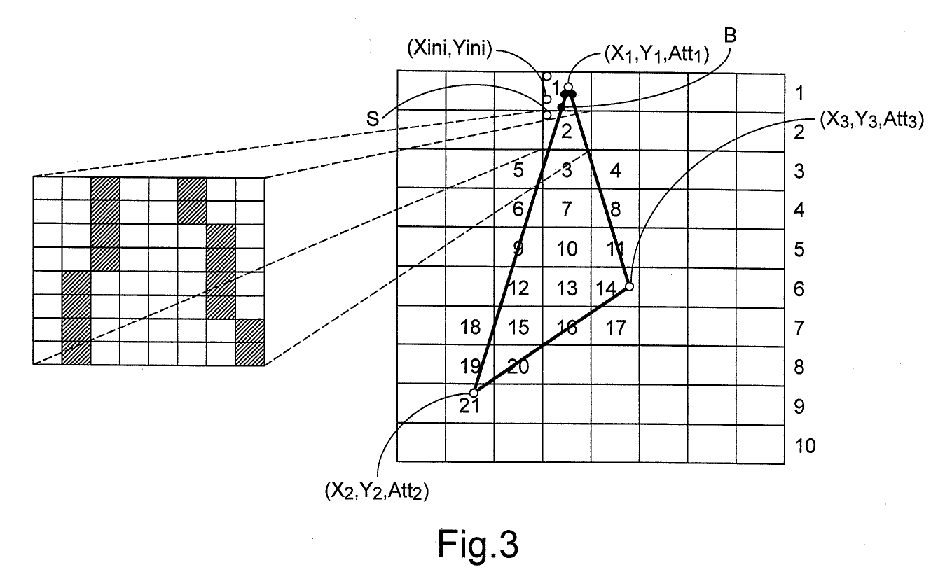

For executing a 3D graphic processing method according to the present invention, the X-Y plane consisting of M×N pixels is divided into a plurality of tiles, each consisting of P×Q pixels, wherein P is preferably but not necessarily a factor of M, and Q is preferably but not necessarily a factor of N. For example, when the X-Y plane consists of 2048×2048 pixels, it means M=N=2048, and P and Q can be selected to be 8. In other words, each tile consists of 8×8 pixels. The triangle then covers a plurality of tiles, as shown in FIG. 3. By locating tiles covering two of the three vertexes with maximum and minimum Y values, setup engine 200 can determine a tile row covered by the triangle and the first tile to be rastered first. In FIG. 3, tile 1 where the maximum Y value of the triangle is located lies in tile row 1 and tile 21 where the minimum Y value of the triangle is located lies in tile row 9. Thus the tile row includes tile 1 through tile 9. The first tile to be rastered is tile 1. Then, setup engine 20 determines a starting point (Xini,Yini) in tile 1, which preferably lies on the left edge of tile 1 so as to make the calculation of the Xini value become easy. Accordingly, Xini is equal to X1-mode(X1,8) where mode(X1,8) is the remainder of X1/8. Likewise, Yini may be equal to Y1-mode(Y1,8) to define a point which is located at the upper left corner of tile 1. Otherwise, Yini may be equal to int(Y1+1⁻) to define the starting point shown in FIG. 3, wherein int(Y1+1⁻) indicates an integer part of (Y1+1⁻) and 1⁻ indicates a value closest to 1 but not equal to 1 under current system precision. Afterwards, setup engine 200 defines three line equations on the X-Y plane and a plane equation according to X- and Y-coordinate values and attribute values of the three vertex points. The three lines are formed with the three vertex points. The plane equation is defined as Att(X,Y)=Att0+Δx•(Att)dx+Δy•(Att)dy, and for example, may be depth-value plane equation Z(X,Y)=Z0+Δx•Zdx+Δy•Zdy or color-value plane equation C(X,Y)=C0+Δx•Cdx+Δy•Cdy. According to the plane equation, the attribute value Attini of the starting point (Xini,Yini) can be calculated. Setup engine 200 then sends information of starting point (Xini, Yini, Attini), (Att)dx, (Att)dy and slope of the three line equations to downstream tile regulator 201 and tile spanner 202 for further processing.

Tile regulator 201 calculates left and right marginal Y values in a tile according to left and right line equations X_{L}=Xini+Δy•(1/m_{L}) and X_{R}=Xini+Δy•(1/m_{R}), where m_{L} and m_{R} are slopes of the two lines. The marginal points are the points to be rastered in this tile, and the X and Y values thereof are sent to tile spanner 202 for further processing. If tile regulator 201 determines that the left or right margin point of a tile needs rasterization, it means there is another tile at the left side or the right side of the current tile in the same tile row needs to be rastered. Likewise, if there are points beyond the bottom margin of the tile needing rastering, it means that there is still a tile or tiles in next tile row required to be rastered.

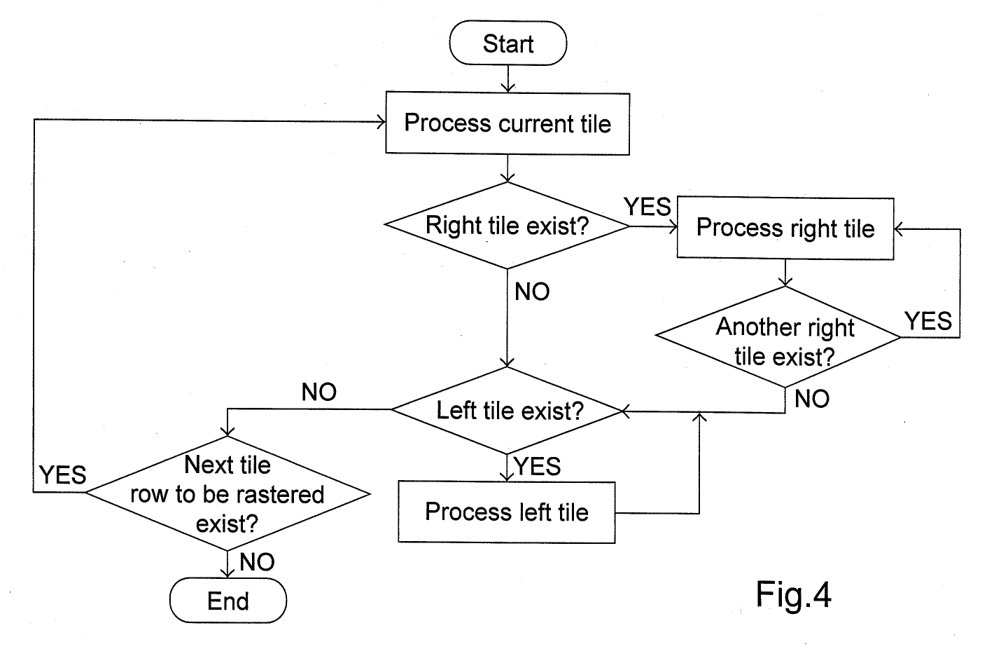

Please refer to the flowchart of FIG. 4, in which the processing order of tiles are illustrated. For taking advantage of pipeline operation, tile regulator 201 determines next tile to be rastered while sending out all points needing rastering. First of all, three kinds of tiles are defined, i.e. current tile, right tile and left tile. The current tile is the one to be rastered first in the same tile row. For example, the tile where the longest left line first passes in a certain tile row will be the current tile. The tile disposed at the right side of the current tile is the right tile, and the tile disposed at the left side of the current tile is the left tile. It is possible to have more than one right tiles and/or left tiles in the same tile row. Whenever moving to next tile row, tile regulator 201 starts with the corresponding current tile, and generates a set of points needing rastering. If there are points to be rastered in the right margin, it means the right tile also needs rastering. After processing the tight tile or all the right tiles, the rastering operation moves to the left tile if there are points to be rastered by tile spanner 202 in the left margin, too. Afterwards, current tile, right tile and left tile in next tile row are determined and processed. The tile numbers 1-21 in FIG. 3 indicate the rastering order based on the above deduction.

When realizing points to be rastered and starting point (Xini, Yini, Attini) in a specified tile and parameters of (Att)dx and (Att)dy, the tile spanner 202 calculates attribute values of those points to be rastered according to the equation Att(X,Y)=Att0+Δx•(Att)dx+Δy•(Att)dy. As described above, the point (Xini,Yini,Attini) is selected as the starting point for processing the first tile 1. Subsequently, any point (preferably edge point) in tile 1 having been rastered can be used as the starting point for processing next tile 2. Likewise, any point (preferably edge point) in a preceding tile having been rastered can be used as the starting point for processing a following tile. Assuming the starting point is defined as S(Xs,Ys,Atts), the attribute values are then obtained according to the equation Att(X,Y)=Atts+Δx•(Att)dx+Δy•(Att)dy.

In the above example, each tile consists of 8×8 pixels, so the bit numbers of Δx and Δy will be no greater than 3. It means the multiplier in the graphics engine just needs to process up to 3-bit multiplying operations. Therefore, the hardware complexity can be significantly reduced. Even when the X-Y plane size increases, the hardware cost of graphics engine could still be well confined.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A 3D graphics processing method, comprising steps of:
dividing a X-Y plane consisting of M×N pixels into a plurality of tiles consisting of P×Q pixels;
inputting X- and Y-coordinate values and attribute values of first, second and third vertex points of a triangle into a geometric engine;
defining a plane equation and three line equations of the triangle by the geometric engine according to the X- and Y-coordinate values and attribute values of the first, second and third vertex points;
calculating an attribute value of a starting point that is located in a first tile along with the first vertex point by the geometric engine according to the X- and Y-coordinate and attribute values of the first vertex point and the plane equation;
inputting information of the starting point, X and Y partial derivatives complying with the plane equation and slopes of the three line equations into a raster engine;
calculating Y values of left and right margins of the triangle in the first tile according to two of the three line equations, thereby locating points in the first tile to be rastered by the raster engine; and
calculating attribute values of the points to be rastered according to information of the starting point and X and Y partial derivatives complying with the plane equation.

2. The method according to claim 1 wherein the starting point is an edge point of the first tile.

3. The method according to claim 1 wherein the attribute values include Z values indicative of depth in 3D space and color values indicative of color.

4. The method according to claim 1 further comprising steps of:
defining a set of tile rows covered by the triangle according to maximum and minimum Y values of the triangle;
defining a current tile to be rastered first, a right tile disposed at the right side of the current tile, and a left tile disposed at the left side of the current tile in a certain tile row, wherein the current tile is the one where the longest edge line of the triangle first passes in the certain tile row;
rastering the current tile, then one of the left and right tiles, and then the other of the left and right tiles in the certain tile row; and
repeating the above steps to process next tile row until there is no tile to be further processed.

5. The method according to claim 4 wherein the right tile is rastered prior to the left tile.

6. The method according to claim 5 wherein more than one right tile is defined in the certain tile row, and the left tile is rastered after all the right tiles are rastered.

7. The method according to claim 1 wherein the X and Y values in the rastering engine are smaller than or equal to P and Q, respectively.

8. The method according to claim 1 wherein P=Q=8.

9. A 3D graphics processing device for processing a X-Y plane, the X-Y plane consisting of M×N pixels being divided into a plurality of tiles consisting of P×Q pixels, the 3D graphics processing device comprising:
a geometric engine defining a plane equation and three line equations of a triangle according to X- and Y-coordinate values and attribute values of first, second and third vertex points of the triangle, calculating an attribute value of a starting point that is located in a first tile along with the first vertex point according to the X- and Y-coordinate and attribute values of the first vertex point and the plane equation, and outputting information of the starting point, X and Y partial derivatives complying with the plane equation and slopes of the three line equations; and
a raster engine in communication with the geometric engine receiving the information of the starting point, X and Y partial derivatives complying with the plane equation and slopes of the three line equations from the geometric engine, calculating Y values of left and right margins of the triangle in the first tile according to two of the three line equations to locate points in the first tile to be rastered, and calculating attribute values of the points to be rastered according to the information of the starting point and X and Y partial derivatives complying with the plane equation.

10. The device according to claim 9 wherein the starting point is an edge point of the first tile.

11. The device according to claim 9 wherein the attribute values include Z values indicative of depth in 3D space and color values indicative of color.

12. The device according to claim 9 further performing operations of:
defining a set of tile rows covered by the triangle according to maximum and minimum Y values of the triangle;
defining a current tile to be rastered first, a right tile disposed at the right side of the current tile, and a left tile disposed at the left side of the current tile in a certain tile row, wherein the current tile is the one where the longest edge line of the triangle first passes in the certain tile row;
rastering the current tile, then one of the left and right tiles, and then the other of the left and right tiles in the certain tile row; and
repeating the above steps to process next tile row until there is no tile to be further processed.

13. The device according to claim 12 wherein the right tile is rastered prior to the left tile.

14. The device according to claim 13 wherein more than one right tile is defined in the certain tile row, and the left tile is rastered after all the right tiles are rastered.

15. The device according to claim 9 wherein the X and Y values in the rastering engine are smaller than or equal to P and Q, respectively.

16. The device according to claim 9 wherein P=Q=8.
